(19) United States
(12) Patent Application Publication
(10) Pub. No.: US 2009/0097476 A1
(43) Pub. Date: Apr. 16, 2009

(54) METHOD AND APPARATUS FOR SUPPORTING VOICE COMMUNICATIONS

(75) Inventors: Pierre Roux, Argenteuil (FR); Marco Fratti, St. Germain En Laye (FR)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/297,442

(22) PCT Filed: Jun. 1, 2007
(86) PCT No.: PCT/US07/70184

§ 371 Date: Oct. 17, 2008

(30) Foreign Application Priority Data
Jun. 23, 2006 (GB) 0612491.1

(51) Int. Cl. H04L 12/66

(52) U.S. Cl. 370/352

(57) ABSTRACT

An apparatus comprises two processors (105, 107) for supporting a remote terminal in a packet and circuit switched mode of operation respectively as well as two interfaces (113, 117) for interfacing to an external circuit and packet switched network (111, 115) respectively. A first selector (109) can select a remote terminal communication link as a packet switched mode communication link or a circuit switched mode communication link and a second selector (119) can select an external voice communication link as a voice communication link of the external circuit switched network (111) or a voice communication link of the external packet switched network (115) in response to an identity of the other party involved in the call. A conversion processor (121) can support the voice communication by conveying voice data between the selected remote terminal communication link and the selected external voice communication link.

### FIELD OF THE INVENTION

The invention relates to a method and apparatus for supporting voice communications and in particular to support of packet switched and circuit switched voice communications.

### BACKGROUND OF THE INVENTION

Traditionally communication systems for supporting voice communications employ circuit switched techniques wherein a continuous connection is formed between the parties involved. However, increasingly, voice communication is being supported by packet switched communications wherein the voice data is divided into different packets that can be separately routed between the parties. For example, Public Switched Telephone Networks (PSTNs) and cellular communication systems, such as GSM, conventionally support voice communication in a circuit switched domain. However, the voice services traditionally supported in this way are increasingly being supported in the packet switched domain for example as Voice over Internet Protocol (VOIP) via e.g. the Internet or other packet switched networks.

Thus, voice traffic is currently in the process of switching from predominantly being supported in the circuit switched domain to predominantly being supported in the packet switched domain. Although all voice communication is likely to eventually be supported in the packet switched domain, the evolution towards this is slow and inter-working between both domains will be important for a very long transitional period. Therefore efficient solutions for interworking of the packet switched and circuit switched domains are needed. Such solutions should preferably provide seamless mobility between the packet switched and circuit switched domains, such as between cellular and WiFi™ access networks.

The solution currently proposed for such interworking is to deploy complex media gateways in the network infrastructure. Such gateways can receive voice data from users in one domain and interface these with a central network operating in a different domain. However, the conventional approach has a number of disadvantages. For example, existing proposals require complex media gateways which for example have to relay high bandwidths in terms of inter-domain voice traffic. This can for example make scalability difficult. Furthermore, support of seamless mobility is more difficult in a centralised approach.

Hence, an improved system would be advantageous and in particular a system allowing increased flexibility, improved reliability, improved mobility support, reduced complexity and/or improved packet switched domain/circuit switched domain interworking would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided an apparatus for supporting voice communications, the apparatus comprising: first support means for supporting a remote terminal in a packet switched mode of operation; second support means for supporting the remote terminal in a circuit switched mode of operation; first selecting means for supporting a voice communication of the remote terminal associated with another party by selecting a remote terminal communication link as a packet switched mode communication link or a circuit switched mode communication link; means for interfacing to an external circuit switched network; means for interfacing to an external packet switched network; second selecting means for selecting an external voice communication link as a voice communication link of the external circuit switched network or a voice communication link of the external packet switched network in response to an identity of the other party; and coupling means for supporting the voice communication by conveying voice data between the selected remote terminal communication link and the selected external voice communication link.

The invention may allow improved circuit switched/packet switched interworking. An improved mobility support for the remote terminal may be achieved. The apparatus may allow a low complexity, lower-cost, scalable and/or distributed seamless support of both circuit switched and packet switched domains. Specifically, the apparatus may be a home gateway that can be distributed and located at e.g. the individual subscriber's home or office. The apparatus may for example be comprised in a user's Internet access equipment. Specifically, the apparatus may in some embodiments allow calls to be made to and from another party by an external circuit or packet switched network and using packet and circuit switched operation of the remote terminal as appropriate without any user involvement being required.

The coupling means may convey data from the selected remote terminal communication link to the selected external voice communication link and/or from the selected external voice communication link to the selected remote terminal communication link.

According to an optional feature of the invention, the apparatus further comprises means for supporting a handover of the remote terminal between the packet switched mode communication link and the circuit switched mode communication link without changing a characteristic of the external voice communication link.

The invention may e.g. allow the efficient utilisation of the most appropriate means of communication for the remote terminal without requiring any modifications or adaptations to be made in the external networks supporting the voice communication.

The handover may be from the packet switched mode communication link to the circuit switched mode communication link; or to the packet switched mode communication link from the circuit switched mode communication link. The handover may be performed without changing the external voice communication link to another configuration. The handover may specifically only involve the remote terminal and the apparatus and may not be known to the supporting external network.

According to an optional feature of the invention, the apparatus is arranged to simultaneously support both the packet switched mode communication link and the circuit switched mode communication link to the remote terminal during a switch interval.

This may allow improved performance and may in particular facilitate and/or improve handover of the remote terminal between the packet switched domain and the circuit switched domain (in either direction). The switch interval may be a handover interval.

According to another aspect of the invention, there is provided a method of supporting voice communications by an apparatus having first support means for supporting a remote terminal in a packet switched mode of operation, second support means for supporting the remote terminal in a circuit switched mode of operation, means for interfacing to an external circuit switched network; and means for interfacing to an external packet switched network; the method comprising: supporting a voice communication of the remote terminal associated with another party by selecting a remote terminal communication link as a packet switched mode communication link or a circuit switched mode communication link; selecting an external voice communication link as a voice communication link of the external circuit switched network or a voice communication link of the external packet switched network in response to an identity of the other party; and supporting the voice communication by conveying voice data between the selected remote terminal communication link and the selected external voice communication link.

These and other aspects, features and advantages of the invention will be apparent from and elucidated with reference to the dependent claims and/or the embodiment(s) described hereinafter.

### BRIEF DESCRIPTION OF THE DRAWINGS

Embodiments of the invention will be described, by way of example only, with reference to the drawings, in which

FIG. 1 illustrates an example of a communication system comprising an apparatus for supporting voice communication in accordance with some embodiments of the invention;

FIG. 2 illustrates a scenario for support of a voice communication by an apparatus in accordance with some embodiments of the invention;

FIG. 3 illustrates a scenario for support of a voice communication by an apparatus in accordance with some embodiments of the invention;

FIG. 4 illustrates a scenario for support of a voice communication by an apparatus in accordance with some embodiments of the invention;

FIG. 5 illustrates a scenario for support of a voice communication by an apparatus in accordance with some embodiments of the invention; and

FIG. 6 illustrates a scenario for support of a voice communication by an apparatus in accordance with some embodiments of the invention.

### DETAILED DESCRIPTION OF SOME EMBODIMENTS OF THE INVENTION

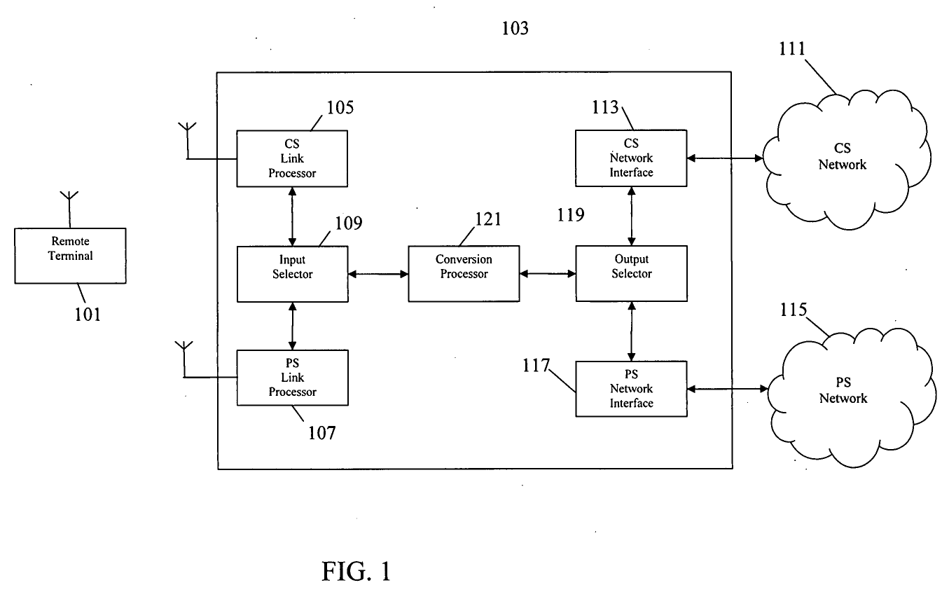

FIG. 1 illustrates an example of a communication system comprising an apparatus for supporting voice communications in accordance with some embodiments of the invention.

The system comprises a remote terminal 101 which is capable of operating both in a circuit switched mode of operation and a packet switched mode of operation. Specifically, the remote terminal is a dual mode remote terminal which comprises functionality for communicating in accordance with any circuit switched cellular communication standard, such as GSM, as well as functionality for communicating in accordance with any packet switched wireless local area network WLAN standard, such as an 802.11 or WiFi™ standard. The embodiments herein make specific reference to GSM and WiFi™ for illustrative purposes only.

Hence, the remote terminal 101 can communicate using a WLAN standard when it is within the coverage of this system and can communicate using the cellular communication standard when it is outside the coverage of the WLAN but within cellular coverage.

In the example, the remote terminal 101 is supported by an apparatus for supporting voice communications. In the specific example the apparatus is a home gateway 103 which can support voice communications within a small area such as within a home of a subscriber.

The home gateway 103 comprises functionality for supporting both circuit switched and packet switched communications with the remote terminal 101. Furthermore, the home gateway 103 supports seamless handover from the packet switch domain to the circuit switched domain and vice versa. Thus, the home gateway 103 allows the remote terminal 101 to be supported by a WLAN when it is within reach of this network while allowing cellular communication techniques to be used to provide coverage outside the area covered by the WLAN.

The home gateway 103 specifically comprises a circuit switched link processor 105 which is arranged to communicate with the remote terminal 101 over a circuit switched cellular communication system link. Specifically, the circuit switched link processor 105 can support a circuit switched communication link to the remote terminal in accordance with the Technical Recommendations for the GSM cellular communication system.

In addition, the home gateway 103 comprises a packet switched link processor 107 which is arranged to communicate with the remote terminal 101 over a packet switched WLAN communication link. Specifically, the packet switched link processor 107 can communicate with the remote terminal 101 through a WiFi™ communication link. The communication link can specifically be in accordance with a Mobile Internet Protocol and can use Voice over Internet Protocol (VOIP) and Session Initiation Protocol (SIP) techniques as will be appreciated by the person skilled in the art.

The circuit switched link processor 105 and the packet switched link processor 107 are coupled to a first selector 109 which is arranged to select whether the communication link to the remote terminal is a packet switched communication link supported by the packet switched link processor 107 or a circuit switched communication link supported by the circuit switched link processor 105. Thus, in the specific example, the first selector 109 selects whether the communication link to the remote terminal should be supported by a circuit switched GSM link or via a packet switched WiFi™ link. The communication link to the remote terminal 101 may be arranged to carry voice traffic from the remote terminal 101, to the remote terminal 101 or both to and from the remote terminal 101. Specifically, the communication link to the remote terminal 101 can be a duplex voice communication link.

The selection of which domain to use for the remote terminal communication link may for example be performed in response to the current mode of operation for the remote terminal 101. For example, if the remote terminal is currently able to communicate with the home gateway 103 using a WLAN communication link, this communication link may be selected as the remote terminal communication link. However, if no communication link can be established or maintained by the WLAN, the first selector 109 can select a circuit switched GSM communication link for the remote terminal link as this typically provides better coverage than a WLAN communication link. Furthermore, the first selector 109 may dynamically select which domain is used for the remote terminal communication link and may specifically support seamless handovers of the remote terminal 101 from one domain to another.

The selection of which domain to use for the remote terminal communication link may be controlled by the home gateway 103 or may be controlled by the remote terminal 101. For example, the remote terminal 101 can comprise functionality for detecting that a WLAN communication link is deteriorating to an extent where it cannot support the voice communication and may in response communicate a handover request message to the home gateway 103. When receiving a handover request message, the first selector 109 can switch the remote terminal communication link to the circuit switched communication link supported by the circuit switched link processor 105.

The home gateway 103 is coupled to an external circuit switched network 111 by a circuit switched network interface 113. Also, the home gateway 103 is coupled to an external packet switched network 115 by a packet switched network interface 117. The circuit switched network 111 is in the example of FIG. 1 a traditional circuit switched telephone system (a PSTN) whereas the packet switched network 115 is the Internet.

The home gateway 103 is thus a network node of both the circuit switched network 111 and the packet switched network 115. Accordingly, the home gateway 103 has at least one address within the circuit switched network 111 and at least one address within the packet switched network 115. Specifically, the home gateway 103 is allocated a telephone number of the PSTN as well as an Internet IP address.

The circuit switched network interface 113 and the packet switched network interface 117 are coupled to a second selector 119 which is arranged to select whether the voice communication of the remote terminal 101 is coupled to a communication link formed via the circuit switched network 111 or a communication link formed via the packet switched network 115. Thus, the second selector 119 selects whether the external communication link providing the link to the other party of the voice communication is established through the PSTN or the Internet.

The selection of the external network is performed depending on the other party involved in the call. Hence, if an incoming call is received from the PSTN, the external communication link is selected as a circuit switched communication link through the circuit switched network interface 113. If an incoming call is received from the Internet, the external communication link is selected as a packet switched communication link through the packet switched network interface 117. If the remote terminal 101 initiates an outgoing call, the external link is selected as a circuit switched link of the circuit switched network 111 if the identity of the called party corresponds to a PSTN identity, and is selected as the packet switched link of the packet switched network 115 if the identity of the called party corresponds to an Internet address.

The home gateway 103 furthermore comprises a conversion processor 121 which is arranged to convey data between the selected external communication link and the selected remote terminal communication link. The conversion processor 121 can generate outgoing voice data for the external communication link from the voice data received on the remote terminal communication link and can generate incoming voice data for the remote terminal from the data of the external communication link.

Thus, the described approach provides a home gateway which allows efficient support of communications in both the packet switched domain and the circuit switched domain. The most suited domain may automatically be selected both internally and externally. The approach may allow a distributed functionality for interworking between packet switched and circuit switched domains and may reduce or remove the requirement for complex media gateways in the external networks. The home gateway 103 may for example be implemented in Internet access equipment provided by an Internet Service Provider. Thus, the home gateway may provide simple and low complexity equipment supporting voice communications for a user. The voice communication may be supported wirelessly by packet or circuit switched operation and may be supported via a PSTN or the Internet as appropriate. Furthermore, the selection of which mode to use for each interface can be made dynamically and automatically and without the involvement or even knowledge of the user. Thus, high user friendliness is achieved with the user simply making a normal call and the home gateway 103 selecting the best way to support this call.

In the following, the operation of the home gateway 103 will be further illustrated by some specific examples.

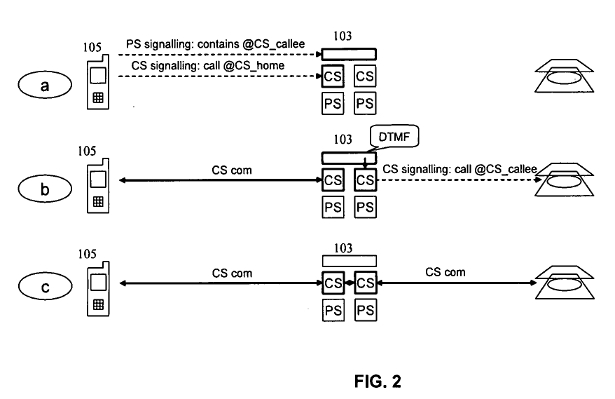

FIG. 2 illustrates a scenario wherein the remote terminal 101 calls a circuit switched (CS) other party through the circuit switched network 111.

In the scenario, a permanent packet switched (PS) signalling IP connection is assumed to exist between the remote terminal 101 and the home gateway 103. This connection may use firewall and NAT traversing techniques as well as Mobile IP.

When the remote terminal 101 initiates a call to another party, the remote terminal initially does two things in parallel:
It contacts the home gateway 103 in order to let it know the other party's phone number. Any suitable protocol can be used for this purpose (e.g. SIP). This signalling can be performed using a packet switched signalling communication link of the WLAN.
It establishes a circuit switched call to the home gateway 103.

Thus, when the user of the remote terminal 101 enters a phone number of another party it wishes to call, the remote terminal 101 generates a signalling data packet comprising this telephone number. The signalling data packet is transmitted to the home gateway 103 over the PS signalling connection. When the data packet is received at the home gateway 103, the home gateway 103 and the remote terminal 101 proceed to establish a circuit switched communication link ready for communication of voice data to and from the remote terminal 101.

Once the home gateway 103 has received the other party's phone number in the signalling data packet, a circuit switched connection is also established from the home gateway to the other party through the circuit switched network 111.

Thus, the signalling data packet from the remote terminal 101 specifies the telephone number of the other party and thereby signals that a voice call over the circuit switched network 111 (the PSTN in the specific example) should be initiated. The home gateway 103 proceeds to use conventional PSTN signalling to set up this call.

Specifically, the home gateway 103 can operate as a conventional telephone and generate an off-hook condition followed by conventional DTMF (Dual Tone Multi Frequency) signalling corresponding to the telephone number.

In addition, the home gateway 103 generates a dialling tone indication which is transmitted to the remote terminal 101 over the circuit switched connection thereby allowing the user to hear that a call is being established.

When the other party responds to the call, the home gateway 103 detects that a call has been successfully established (e.g. from explicit signalling or from a detection of an off-hook condition). It then proceeds to link the external circuit switched connection of the circuit switched network 111 with the circuit switched connection to the remote terminal 101.

The conversion processor 121 exchanges voice data between the circuit switched connections of the remote terminal communication link and the external communication link.

The exact nature of the voice exchange functionality may depend on the specific characteristics of the external and the remote terminal communication links. For example, the remote terminal 101 may support a GSM circuit switched communication link. In this case the voice of the user of the remote terminal 101 is digitized and encoded in accordance with the GSM speech encoding standard. It is then transmitted to the home gateway 103 in accordance with the air interface standards of GSM.

The home gateway 103 receives the GSM communication and extracts the GSM voice encoded data.

Depending on the nature of the external communication link, the home gateway 103 may perform different functions to ensure that the voice data is compatible with the external communication link. For example, for a digital connection to the PSTN, simple (companded) Pulse Code Modulated (PCM) voice data may typically be used. In this case, the home gateway 103 converts the GSM voice data to PCM modulated data which is then transmitted to the other party via the external communication link. The conversion may simply be achieved by first performing a GSM voice decoding of the received GSM voice data followed by an encoding according to the specific requirements for the PCM signal (e.g. the signal may be re-quantised and/or resampled). In an example where the external communication link is a traditional analog communication link to the other party, the home gateway 103 may simply decode the GSM voice data, convert it to the analog domain and output the resulting analog signal to the external communication link.

Similarly, the other party will generate voice data which is received by the home gateway 103. This voice data may e.g. be a companded PCM signal. In this case, the home gateway 103 generates a non-companded (and possible resampled signal) which is fed to a GSM voice encoder. The GSM voice encoder then generates the corresponding GSM voice data which is transmitted to the remote terminal 101 over the circuit switched connection. The remote terminal 101 treats this signal as any other GSM signal and proceeds to decode it using the conventional GSM voice decoder.

Thus, the home gateway 103 can initiate a circuit switched call to another party in response to receiving a call setup request via the packet switched signalling communication.

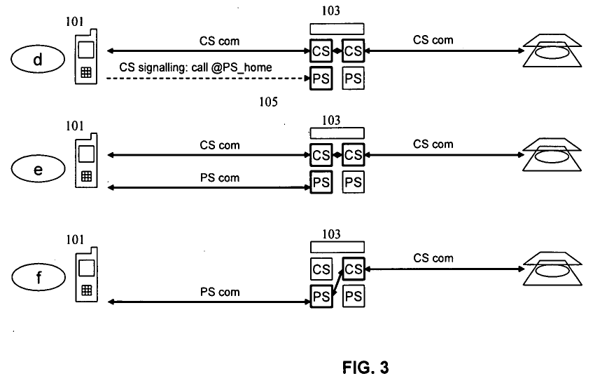

FIG. 3 illustrates a scenario wherein the remote terminal 101 is handed over from the cellular communication link to a WLAN communication link. Such circuit switched to packet switched handover may be required by the remote terminal because e.g. WLAN coverage has been detected during the communication.

In the example, the remote terminal 101 can establish a packet switched voice communication link with the home gateway 103 while the circuit switched remote terminal communication link is still supported. Thus, during a switch interval, the home gateway 103 supports both circuit switched and packet switched communication via the GSM and WLAN links respectively.

Specifically, for an ongoing call which has been set up as described for FIG. 2, the remote terminal 101 may at some point detect that it is possible to communicate with the home gateway 103 using the WLAN packet switched connection.

The remote terminal 101 then proceeds to transmit a WLAN connection initialisation message to the home gateway 103 using the signalling IP connection. In response, the home gateway 103 and remote terminal 101 sets up a WLAN packet switched communication link while still maintaining the circuit switched connection.

The remote terminal 101 proceeds to generate packet switched voice data and to transmit this to the home gateway 103 via the packet switched connection. In some cases, the packet switched connection and the circuit switched connection may use the same voice encoding and the same data can be transmitted on both links. However, in other embodiments, different voice encoding standards can be used and the remote terminal 101 may feed the voice samples to two different voice encoders for generation of separate voice data for the circuit switched and packet switched connections.

The packet switched connection can specifically use a VOIP connection for the communication.

Similarly to the circuit switched connection, the packet switched connection is a bidirectional connection (e.g. it can comprise two individual sub-connections). Thus, the home gateway 103 also transmits voice data received from the external communication link on the packet switched connection to the remote terminal 101. Again, the data transmitted on the packet switched connection may in some embodiments be the same as that transmitted on the circuit switched connection. However, in other scenarios, the home gateway 103 may use a second voice encoder to convert the received PCM data to voice encoded data in accordance with the voice encoding standard used for the packet switched communication.

Thus, the home gateway 103 and remote terminal 101 set up parallel circuit switched and packet switched connections during a switch interval. During this switch interval, the first selector 109 then switches the remote terminal communication link used by the conversion processor 121 from the circuit switched connection to the packet switched connection after which the circuit switched connection may be terminated. Thus, the handover may be performed as a make-before-break handover with no disruption perceivable by the user.

Specifically, the remote terminal 101 and the home gateway 103 may both detect that the packet switched connection is operating correctly and may transmit this indication to the other unit. When the remote terminal 101 receives the indication that the packet switch connection is operating correctly at the home gateway 103, it switches the receipt of voice data from the home gateway 103 from the circuit switched connection to the packet switched connection. It then transmits an indication that this switch has been completed to the home gateway 103. In response, the home gateway 103 proceeds to terminate the circuit switched transmissions from the home gateway 103 to the remote terminal 101.

Similarly, when the home gateway 103 receives the indication that the packet switch connection is operating correctly at the remote terminal 101, it switches the receipt of voice data from the remote terminal 101 from the circuit switched connection to the packet switched connection. It then transmits an indication that this switch has been completed to the remote terminal 101. In response, the remote terminal 101 proceeds to terminate the circuit switched transmissions from remote terminal 101 to the home gateway 103.

Accordingly, a seamless transition from the circuit switched connection to the packet switched connection has been achieved.

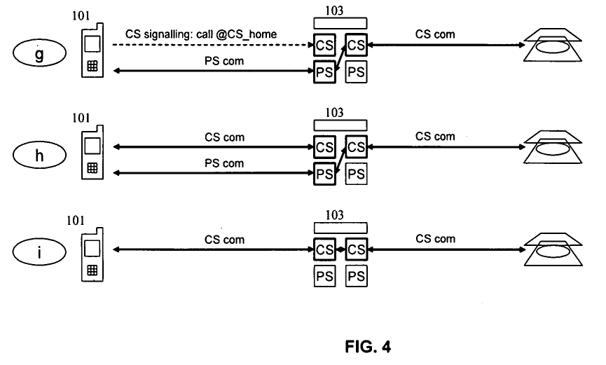

The same principle may be used to execute handovers of the remote terminal 101 from the packet switched domain to the circuit switched domain as illustrated in FIG. 4.

Specifically, if the remote terminal 101 detects that the WLAN packet switched connection is deteriorating, it may proceed to instigate a new packet switched connection and send an indication of this to the home gateway 103 over the signalling IP connection. The home gateway 103 and remote terminal 101 can then proceed to set up parallel connections similarly to the example of FIG. 3. When both connections are operating correctly, the first selector 109 then switches the remote terminal communication link used by the conversion processor 121 from the packet switched connection to the circuit switched connection after which the packet switched connection may be terminated.

The handover of the remote terminal 101 from one domain to another may be performed without any impact on the external communication link and specifically may be performed without any knowledge, involvement or impact on the operation in the external networks.

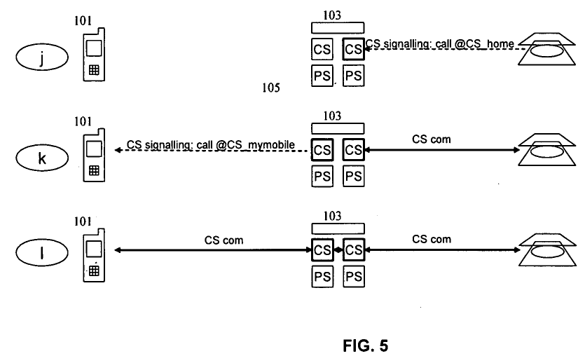

FIG. 5 illustrates a scenario wherein the remote terminal 101 is called by a circuit switched caller through the circuit switched network 111.

In this example, instead of calling the remote terminal's own circuit switched telephone number, the other party calls the phone number of the home gateway 103. When receiving the call the home gateway 103 then pages the remote terminal 101 and sets up a call using the circuit switched connection. The home gateway 103 then proceeds to acknowledge the call from the other party and to establish the communication with this.

The home gateway 103 then proceeds to support the call as described with respect to FIGS. 2 to 4. In particular, the conversion processor 121 exchanges data between a circuit switched remote terminal communication link and a circuit switched external communication link.

In some scenarios, the home gateway 103 may furthermore determine which mode the remote terminal 101 currently is in and may select whether to access the remote terminal 101 in the packet switched domain or the circuit switched domain accordingly. For example, the home gateway 103 may determine whether the remote terminal 101 is currently supported by the WLAN. If so, the call may be setup via the WLAN using packet switched communication. If not, the call may be setup using the circuit switched communication link of the GSM communication.

The mobility scenarios of FIGS. 3 and 4 are equally applicable to the scenario of FIG. 5. Specifically, during the call, the home gateway 103 and the remote terminal 101 may handover between the circuit switched and packet switched domains as previously described with reference to FIGS. 3 and 4.

The home gateway 103 can be set up to cover the entire home environment. Accordingly all the home users (e.g. a family) can be registered in the home gateway 103. In such a scenario, the home gateway 103 can have a number of different external network addresses corresponding to the remote terminals of the different members of the family. Specifically, the home gateway 103 can have as many PSTN phone numbers or IP addresses as there are members in the family.

The home gateway 103 may then select the specific remote terminal to access depending on which of the external addresses the incoming call is directed to. In particular, the home gateway 103 can have a look-up table which correlates the allocated external network addresses to an identity of the individual remote terminal.

As another example, a specific message handshake can be performed between the other party and the home gateway 103. The home gateway 103 can request the other party to dial a specific single-number extension corresponding to the identity of the family member being called. This approach can be implemented by extensions to the LAPD protocol (e.g. S-interface in the SS7 networks) and to the ISUP protocol (e.g. between SS7 nodes).

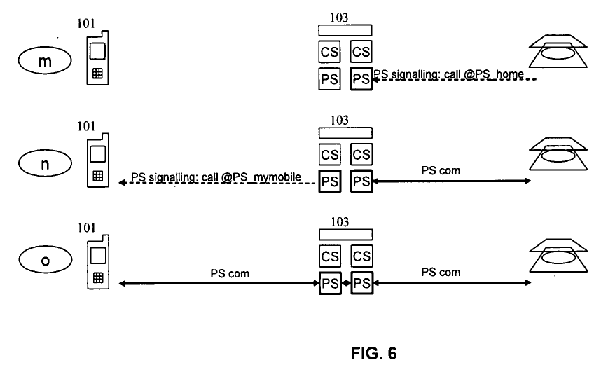

FIG. 6 illustrates a scenario wherein the remote terminal 101 is called by a packet switched caller through the packet switched network 115.

The example is similar to the example of FIG. 5 except that the voice call is received from the packet switched network 115 and is directed to an address of the home gateway 103 in the packet switched network 115. Furthermore, in the example, the connection to the remote terminal 101 is initially set up as a packet switched connection but could in other scenarios be set up as a circuit switched connection.

The conversion processor 121 comprises functionality for interfacing between the requirements for the selected remote terminal communication link and the requirements for the external communication link. Specifically, the conversion processor 121 has information of the voice encoding scheme specified for each of the possible communication links as well as the different data protocols and specifications. Furthermore, the conversion processor 121 can interface between the selected links such that each communication link is supported using the protocols and requirements standardised for that communication link.

For example, the conversion processor 121 can comprise functionality for receiving voice data via the circuit switched remote terminal communication link. This voice data is structured in accordance with the requirements for GSM, and the conversion processor 121 may extract the voice data and embed it in suitable data packets for communication over the packet switched network 115. Thus, specifically, the conversion processor 121 can comprise functionality for converting between GSM data and VOIP data (in both directions).

As another example, if the external communication link is a circuit switched communication link of the PSTN, the conversion processor 121 can convert data from (to) the PSTN data to (from) the VOIP data or GSM data depending on which domain is used for the communication with the remote terminal.

In some cases, the voice encoding scheme used for the remote terminal communication link is the same as the voice encoding scheme used for the external communication link. For example, the GSM voice encoding scheme may also be used for VOIP communication. In such an example, the conversion processor 121 may simply extract and repackage the voice data in accordance with the protocols of the remote terminal communication link and the external communication link.

However, in other scenarios, the voice encoding schemes of the remote terminal communication link and the external communication link may be different. In such a scenario, the conversion processor 121 can interface between the remote terminal communication link and the external communication link by decoding and re-encoding the data. For example, if the remote communication link is currently a circuit switched communication link, the GSM voice data received from the remote terminal may be decoded to provide a sampled unencoded representation of the underlying analog voice signal. The signal may then be re-encoded using the voice encoding scheme of the selected external communication link, such as a G.711 compressed pulse code modulation (PCM) voice encoding scheme frequently used in PSTN networks.

It will be appreciated, that the conversion processor 121 may be arranged to dynamically select between the different conversions depending on which communication links are currently selected to support the voice communication. Specifically, the conversion processor 121 can be arranged to switch the conversion in response to a handover of the remote terminal 101 from one domain to another.

In some embodiments, the home gateway 103 may furthermore comprise functionality that supports billing for the voice communications. Specifically, the home gateway 103 can comprise functionality for storing call detail records for the calls being supported by the home gateway 103. The call detail records can specifically contain information of the communication links that were used to support the call.

For example, for each call the call detail record can contain an indication of the time the call was supported by the circuit switched remote terminal communication link and the packet switched remote communication link respectively as well as the time the call was supported by the circuit switched external communication link and the packet switched external communication link respectively. The call detail records can then be uploaded to a central billing server and can be used to generate detailed billing information which may take into account the actual communication links used. This may allow a flexible billing structure to be implemented.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. An apparatus for supporting voice communications, the apparatus comprising:
first support means for supporting a remote terminal in a packet switched mode of operation;
second support means for supporting the remote terminal in a circuit switched mode of operation;
first selecting means for supporting a voice communication of the remote terminal associated with another party by selecting a remote terminal communication link as a packet switched mode communication link or a circuit switched mode communication link;
means for interfacing to an external circuit switched network;
means for interfacing to an external packet switched network;
second selecting means for selecting an external voice communication link as a voice communication link of the external circuit switched network or a voice communication link of the external packet switched network in response to an identity of the other party; and
coupling means for supporting the voice communication by conveying voice data between the selected remote terminal communication link and the selected external voice communication link.

2. The apparatus of claim 1 wherein the first selecting means is arranged to select the remote terminal link in response to a detection of a current mode of operation of the remote station.

3. The apparatus of claim 1 wherein the first selecting means is arranged to switch the remote terminal communication link between the packet switched mode communication link and the circuit switched mode communication link in response to a switch of a mode of operation of the remote terminal.

4. The apparatus of claim 1 comprising means for supporting a handover of the remote terminal between the packet switched mode communication link and the circuit switched mode communication link without changing a characteristic of the external voice communication link.

5. The apparatus of claim 3 wherein the apparatus is arranged to simultaneously support both the packet switched mode communication link and the circuit switched mode communication link to the remote terminal during a switch interval.

6. The apparatus of claims 3 wherein the coupling means is arranged to interface between a circuit switched communication link and a packet switched communication link.

7. The apparatus of claim 6 wherein the coupling means comprises means for extracting voice data from data of the remote terminal communication link and for generating data for the external voice communication link in accordance with a protocol of the external voice communication link.

8. The apparatus of claim 6 wherein the coupling means comprises means for decoding voice data of the remote terminal communication link in accordance with a voice encoding scheme of the remote terminal communication link and for re-encoding the voice data using a voice encoding scheme of the external voice communication link.

9. The apparatus of claim 1 wherein the apparatus has an associated first external network address and further comprises:
means for receiving an incoming call from one of the external networks, the incoming call being addressed to the first external network address;
means for determining a current switched mode of operation of the remote terminal;
means for setting up a call to the remote terminal using a packet switched mode communication link or a circuit switched mode communication link in response to the current switched mode of operation.

10. The apparatus of claim 9 wherein the apparatus has a plurality of different associated external network addresses corresponding to different remote terminals and the means for setting up the call to the remote terminal is arranged to select the remote terminal in response to a comparison between the first external network address and the plurality of external network addresses.

11. The apparatus of claim 1 wherein the packet switched mode communication link is a communication link of a Wireless Local Area Network.

12. The apparatus of claim 1 wherein the circuit switched mode communication link is a communication link of a cellular communication system.

13. The apparatus of claim 1 wherein the external circuit switched network is a telephone network.

14. The apparatus of claim 1 wherein the external packet switched network is an Internet network.

15. The apparatus of claim 1 wherein the first support means comprises means for supporting a packet switched signalling communication from the remote terminal.

16. The apparatus of claim 12 further comprising means for initiating a circuit switched call to the other party in response to receiving a call setup request via the packet switched signalling communication.

17. The apparatus of claim 1 wherein the first support means is arranged to support communication in accordance with a Mobile Internet Protocol.

18. The apparatus of claim 1 wherein the apparatus further comprises:
means for storing call detail records, the call detail records comprising an indication of at least one of the selected remote terminal communication link and the selected external voice communication link; and
means for transmitting the call detail records to a billing centre of at least one of the external networks.

19. A method of supporting voice communications by an apparatus having first support means for supporting a remote terminal in a packet switched mode of operation, second support means for supporting the remote terminal in a circuit switched mode of operation, means for interfacing to an external circuit switched network; and means for interfacing to an external packet switched network; the method comprising:
supporting a voice communication of the remote terminal associated with another party by selecting a remote terminal communication link as a packet switched mode communication link or a circuit switched mode communication link;
selecting an external voice communication link as a voice communication link of the external circuit switched network or a voice communication link of the external packet switched network in response to an identity of the other party; and
supporting the voice communication by conveying voice data between the selected remote terminal communication link and the selected external voice communication link.

20. (canceled)
